(19) United States
(12) Patent Application Publication
(10) Pub. No.: US 2002/0069128 A1
(43) Pub. Date: Jun. 6, 2002

(54) Method of utilization of E-Business system solution and of access to sources

(76) Inventor: David Beran, Mirovice-Velen (CS)

Correspondence Address: Marc S. Hanish, THELEN REID & PRIEST LLP, P.O. BOX 640640, San Jose, CA, 95164, US

(21) Appl. No.: 09/938,350

(22) Filed: Aug. 23, 2001

(30) Foreign Application Priority Data
Dec. 4, 2000 (CS) PV 2000-4526

(51) Int. Cl. G06F 17/60

(52) U.S. Cl. 705/26

(57) ABSTRACT

A method of utilization of an E-Business system solution and of access to information sources is provided which identifies a client and a source and distributes the data stream on demand. Both analog and digital data may be used by the system. The proposed solution is based on the identification of a client after his entry to the system. Upon receipt of a data stream demand from the Client, the system identifies the required data source and at the same time it sets up a secured transfer channel together with performing data stream distribution process optimizing. The system also may reserve for the client a channel for optional feedback. The data sources are the providers and/or distributors of services, information, or goods. The method of sale or distribution is then ensured by the data stream transfer.

### CROSS REFERENCE TO RELATED APPLICATION

This application claims priority based on Czechoslovakian Application PV 2000-4526, entitled “Method of Utilisation of E-Business System Solution and of Access to Sources”, by David Beran, filed Dec. 4, 2000.

### FIELD OF THE INVENTION

The present invention relates to Electronic Business (“E-Business”). More particularly, the present invention relates to a method of utilization of an E-Business system solution and of access to information sources.

### BACKGROUND OF THE INVENTION

The most frequent form of data stream distribution on the Internet are Internet file archives and providers of video and music data streams.

Internet file archives generally use the File Transfer Protocol (FTP) transfer modes. Access to these FTP archives is either free of charge or for pay, or there is applied another restriction (e.g. previous registration, membership in some enclosed users group, etc.). Access to files may be obtained using either a standard connection or a high-capacity connection. Standard connections are easy to set-up and fairly cheap, however download speeds may be slow, especially when downloading large files. A two-channel connection is generally much faster, as a demand is sent by a first, slower connection but the required data stream itself is sent by a second, quicker connection. A typical example of a high capacity connection is a satellite download service.

Thus, providers of video data streams generally enable two types of transfer: (1) On the same channel which demands the data stream; and (2) On a different channel than the channel which demands the data stream. Option (1) is mainly used on channels capable of managing high volumes of data at the required rate. These include Tier 1 (T1) lines, DSL lines, and cable modem lines. Option (2) is mainly used where a connection following option 1 is difficult to make, such as one-way satellite transmission. Generally, the demand for the data stream is sent via an ordinary channel such as a telephone connection.

There are a lot of Internet services available using the standard connection. One such service is music data transfer. A standard telephone line connection at 33.6 Kbps is usually enough for music data transfer, thus permitting the delivery of high quality digital sound to home computers via the Internet.

Generally, there are two ways for music data transfer to occur. First, the music data may be completely transferred before it is played. Second, the music may begin playing during the transfer. Services such as Napster, Inc. (http://www.napster.com) and Gnutella (http://www.gnutella.com) utilize the first method, whereas services such as Internet radio utilize the second.

Data transfers related to purchase of goods, such as the purchase of airline tickets, are also fairly common on the Internet. Airline customers have several choices on how to purchase a ticket now, including a retail visit such as an airline agent or travel agency, or online via an airline web page or travel agency web page.

In the case of a retail visit to the airline, you have to appear in person in an airline office and the personnel there will offer you the (presumably) best connection meeting your needs, although with some limitations. They will offer you just the flights with their airline, or with a partner airline. It is clear that the best connection at the best price is not obtained in this manner, as there is no price competition.

In case of travel agency, the chance to get better connection/price ratio is higher, since the travel agency is not bound to one airline, but is instead connected to some global air tickets booking system (e.g. Galileo, Sabre, Amadeus, etc.), which are linked up via IATA (International Air Transport Association).

Airline Web Pages are quicker and arguably more comfortable to buy tickets from than the retail outlets, but are again limited to the flights with this airline.

Web pages of travel agencies enable the “on-line” purchase of air tickets, but normally just in a limited range and these electronic purchases are usually related to the flights bound with the tours of these travel agencies. There are also some travel agencies specializing in the sale of air tickets, but they are limited by the capabilities of the electronic booking system they use.

The data stream transfers ensuring the air tickets purchase and booking are not secured. In the case of booking, the information is authorized just based on data provided by the booking agent—in most cases it is just the consumers name and surname, and sometimes passport number. A credit card is usually used for payment for the air ticket and the data is often either without additional protection, or just on a level provided by an ordinary web browser. In any case, at the end of this transaction, a standard, paper air ticket is issued after physical verification of the payer, either on the airport or in the travel agency office. There are just two authorities world-wide which are entitled to issue (print) air tickets: airlines and travel agencies linked up in IATA. The prices of those air tickets are stated by agreements between the single airlines and companies operating the booking systems.

The payments are effectuated via the Business Server Provider (BSP) system, which ensures the clearing between GRS (Global Reservation System) and airlines. Differences between “paper” airline tickets and their electronic equivalent lie just in their booking time requirements, possibility of their use (dependence on the country, airline and certain airport) and cancellation possibility. In the case of the “paper” airline ticket, the cancellation is generally free of charge up to the moment of their issue itself by the booking office representative. This issue (in principle simply printing out) takes usually place 48 hours to 4 days before departure. Certain fees are charged in case of cancellation after this print out, the fee is usually between 20-40% of the purchase price (discounts, if any, are often taken into consideration). Furthermore, in the case of cancellations, the frequency of flights of the customer is often taken into consideration, as well as the class of the air ticket. For example, the first class airline ticket cancellation fee is often much cheaper than that of business class and again that one is cheaper than of economy class.

### BRIEF DESCRIPTION OF THE INVENTION

A method of utilization of an E-Business system solution and of access to information sources is provided which identifies a client and a source and distributes the data stream on demand. Both analog and digital data may be used by the system. The proposed solution is based on the identification of a client after his entry to the system. Upon receipt of a data stream demand from the Client, the system identifies the required data source and at the same time it sets up a secured transfer channel together with performing data stream distribution process optimizing. The system also may reserve for the client a channel for optional feedback.

The data sources are the providers and/or distributors of services, information, or goods. The method of sale or distribution is then ensured by the data stream transfer. The data stream distribution process is optimized by choice of path and/or time and/or data stream distribution mode. Identification of the client as well as of the source may be included into the transferred data during the providing of secured channel.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a data stream provided through the system in accordance with a specific embodiment of the present invention.

FIG. 2 is a diagram illustrating a data stream provided into a secured channel in accordance with a specific embodiment of the present invention.

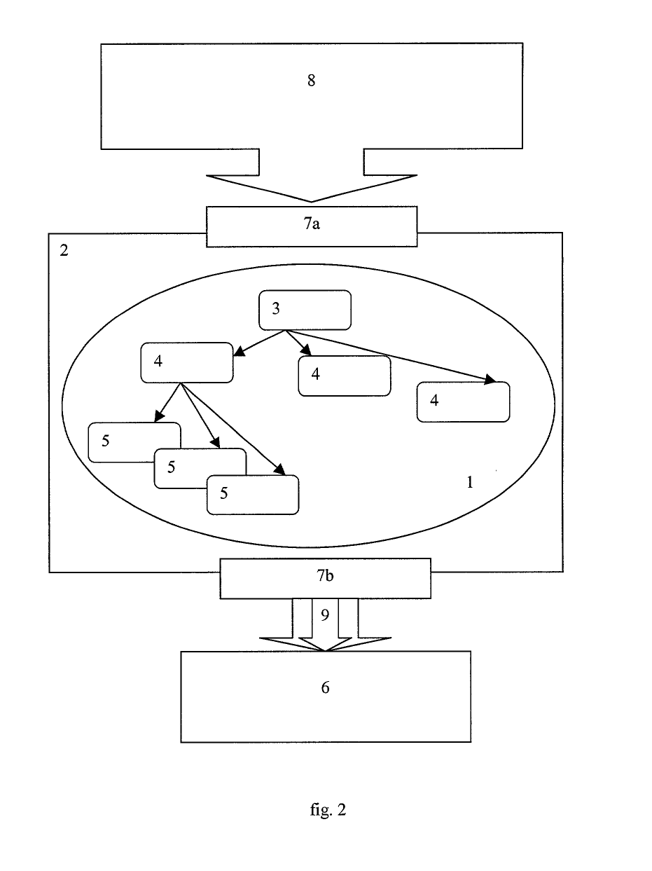

FIG. 3 is a diagram illustrating secured access at a data stream provider in accordance with a specific embodiment of the present invention.

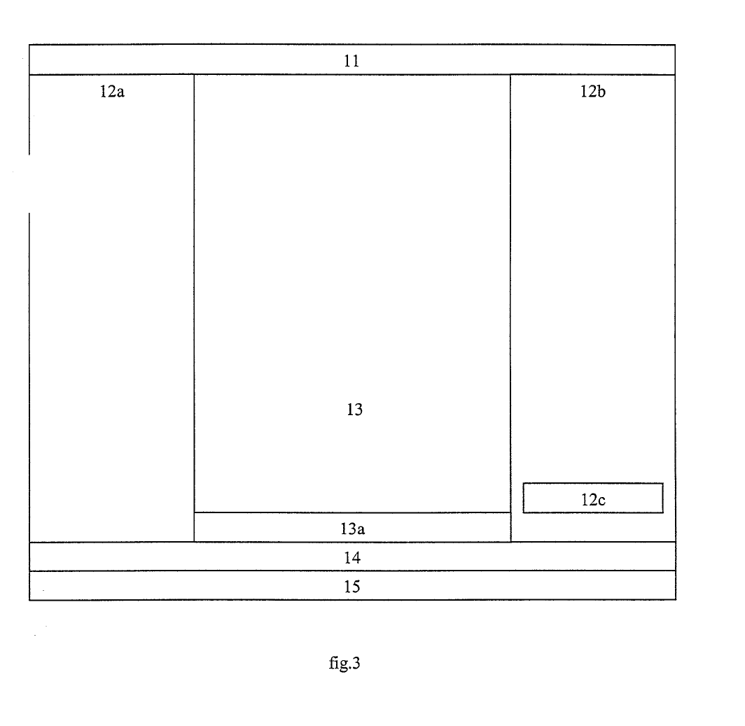

FIG. 4 is a flow diagram illustrating a method for providing a data stream to a client from a source.

### DETAILED DESCRIPTION

Embodiments of the present invention are described herein in the context of a system of computers, servers, communication mechanisms, and tags. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

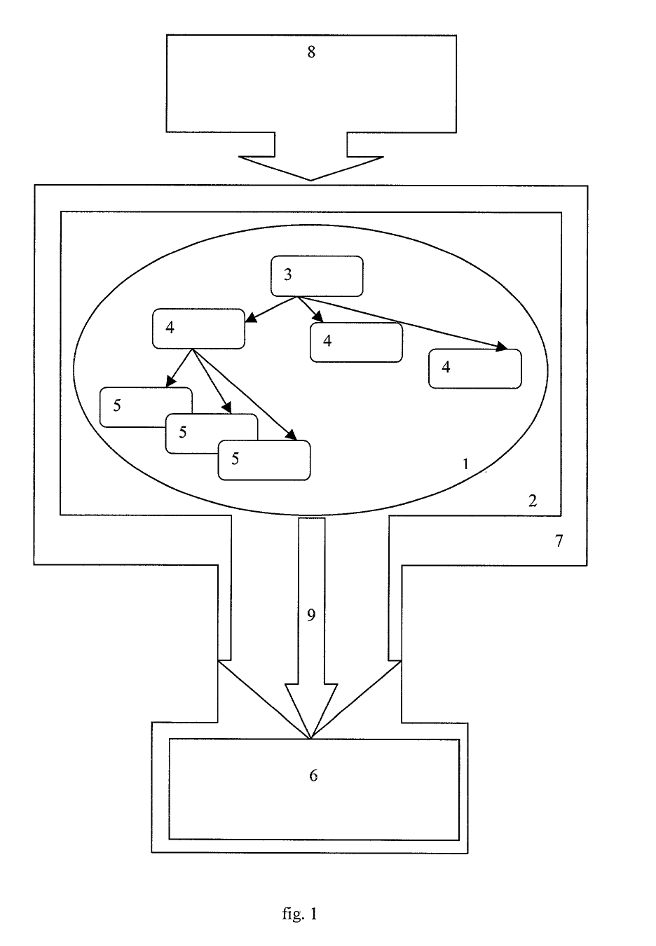

FIG. 1 is a diagram illustrating a data stream provided through the system in accordance with a specific embodiment of the present invention. The method in accordance with a specific embodiment of the present invention creates this data stream System 6. The system comprises at least one operator server and one central server. There may also be at least one national server. Each national server may have one or more operator servers corresponding to it. The individual servers are interconnected in an enclosed network technically implemented by means of virtual interconnections on rented lines, or by own interconnections, or by other means of communication, so as to enable only secured entry, both between individual servers and between operator servers and clients.

The Client 1 of the System 6 is unequivocally identified at the entry to the System 6 by noninterchangeable identification. The Client 1 receives the identification at the conclusion of an agreement with the Operator. This way the obtained information is verified by the Client 1 at the time of his first entry to the System 6, before he is given a Client's identification. The Client's identification may be a PIN, chip card or another means suitable for noninterchangeable identification. Single sources 3 of the goods, services and information are contractually bound with one Operator Server owner or directly with Central Server owner. They provide their sources 3 to the entire System 6. Sources 3 are unequivocally identified based on information provided to the Operator at the time of contractual entry to System 6.

The System 6 provides the data streams 2 on demand of a Client 1 via a secured channel 4, which is a part of the System 6. The data stream 2 bears the identification of the Client 1, who has requested it, as well as of the Source 3, which has provided it. Based on the information included in the transferred data stream it is possible to trace the data stream back and to identify the Client 1 who has requested it, as well as the Source 3 which had provided it within the scope of the System 6.

The Client 1 may be offered a Channel 5 for optional feedback, based on which he can provide the System 6 additional information during the receipt of the requested data stream 2.

An example of a use of the present invention is to utilize the system solution for transfer of video and audio data streams 2 on demand with optional feedback. The Client 1 may utilize this principle at watching live broadcasting, TV on demand, or duplex TV broadcasting (i.e. TV broadcasting with optional feedback or interactive games, which utilize the feedback from the Client 1). The method used is that the System 6 provides the Client 1 with a secured channel 4 for data stream 2 transfer to the Client 1—and at the same time the channel 5 for optional feedback into the System 6. The System 6 will then be able to evaluate the feedback and to provide the results thereof to the Source 3 on demand, or to provide the Source with the feedback directly. An example of feedback may be the answer to the question being asked on a TV game show. In case of interactive games, the feedback may be even more detailed.

In the case of the purchase of airline tickets, the Client 1 and the Source 3 may utilize the System 6 for the transaction. The Client 1 who has entered the System 6, has been unequivocally identified. The Client 1 requests the data stream 2, which represents the offer of airlines or travel agencies (e.g. ticket class and price). The Client's choice is then transferred via channel 5 for optional feedback. The complete transaction is ensured by secured channel 4, which enables in any time the unequivocal identification of the data stream 2, Client 1 and Source 3. This three-sided safety identification provides a distinct advantage over prior art solutions.

Furthermore, the proposed solution provides the Client 1 with another advantage in that he knows exactly whom he is purchasing from and only paying for the services he demanded. The fact that just one identification document (e.g. passport, driving license, chip card, etc.) was used to access the system is an added bonus. Additionally, the costs related with checking passenger identification when the air ticket is issued need not be incurred anymore because the System 6 and identification document of the Client 1 may be used for unequivocal identification.

Thus, the present invention provides for:

(1) completely transparent and safe execution of electronic business, e.g.. of payments for executed data streams transfers demanded by the Client, wherein the system grants warranties both to the Client and to the provider of services.

(2) quick and simple access to any information (data streams) from electronic sources without need of special knowledge or skills (i.e. knowledge of electronic addresses, control of search engines).

(3) warranty of observing the license agreements and copyrights—the system will have the unique ability to warrant to distribution companies the control of observing the license rights, thanks to the agreements concluded with the distributors of the media requiring this protection.

(4) mass pervasion of on demand data streams providing utilization by the group of users who do not possess special knowledge.

(5) the possibility to switch quickly over to another standard on a mass scale for utilization of on-demand data streams providing patented systems, thanks to central system administration. This includes things such as a change of communication protocol, system coding, or copyright securing system for any communication channel of any form.

(6) unified, high safety level, including a warranty of delivery date.

(7) clear contractual relations between data owners (providers) or license owners.

(8) simple and unified control and information search—the same control form for all products provided on the data stream transferred to the Client.

(9) the providing of authorized data streams—when it is necessary it is possible to utilize the system to warrant the data contents, e.g. for the data veracity, legality to distribute (copyright, etc.).

(10) removal of language barriers and versions—the system is able overcome the language barriers preventing some data stream distribution, e.g. TV broadcasting, where it will be possible to insert one channel with simultaneous translation into several languages (this service will be provided by the operator). The national operator may ensure the adaptation of the data stream to make them easily commercially viable. For example, the viewing rate of the channels translated into the local language will substantially increase.

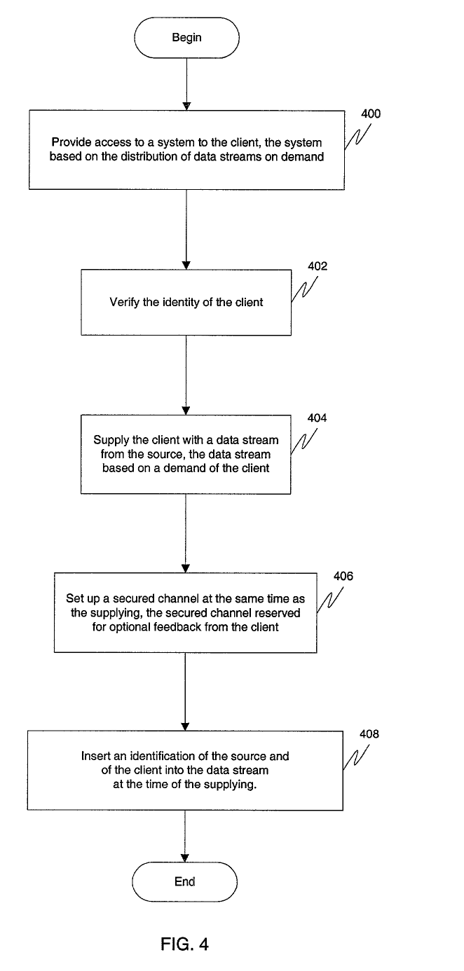

FIG. 4 is a flow diagram illustrating a method for providing a data stream to a client from a source. At 400, access to a system is provided to the client, the system based on the distribution of data streams on demand. At 402, the identify of the client is verified. At 404, the client is supplied with a data stream from the source, the data stream based on the demand of the client. At 406, a secured channel is set up at the same time as the supplying, the secured channel reserved for optional feedback from the client. At 408, an identification of the source and of the client is inserted into the data stream at the time of the supplying.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for providing a data stream to a client from a source including:
providing access to a system to the client, said system based on the distribution of data streams on demand;
verifying the identity of the client;
supplying the client with a data stream from the source, said data stream based on a demand of the client; and
setting up a secured channel at the same time as said supplying, said secured channel reserved for optional feedback from the client.

2. The method of claim 1, wherein the source is a provider and/or distributor of services, information, or goods, the sale or distribution thereof ensured by said data stream transfer.

3. The method of claim 1, wherein said supplying is optimized by choice of a path and/or time and/or distribution method.

4. The method of claim 1, further including inserting an identification of the source and of the client into said data stream at the time of said supplying.
